(19) United States
(12) Patent Application Publication
(10) Pub. No.: US 2026/0288868 A1
(43) Pub. Date: Sep. 24, 2026

(54) PIPELINE FOR INTELLIGENT GENERATION OF DATA ASSET STRUCTURES WITH TRANSPARENT WORKFLOW TRACKING

(71) Applicant: Capital One Financial Corporation, McLean, VA (US)

(72) Inventors: Kenrick Fernandes, Wheeling, IL (US); Ted Conway, Chicago, IL (US); Naresh Vuppala, Columbus, OH (US); Esther Nadler, Phoenix, AZ (US); Julie Perl, Long Grove, IL (US); Kaito Garcia, San Diego, CA (US)

(21) Appl. No.: 19/088,426

(22) Filed: Mar. 24, 2025

(51) Int. Cl. G06F 16/901

(52) U.S. Cl. CPC G06F 16/9024

(57) ABSTRACT

A computing platform is configured to (i) generate a network graph that encodes a representation of (a) a plurality of existing data assets, (b) respective relationships between the data assets, and (c) respective consumption activity, for each data asset, by one or more users, (ii) receive, as input, design parameters for a new data asset structure to be used for a new data asset, (iii) based on the design parameters, select a network optimization algorithm to apply to the network graph, (iv) utilize the network optimization algorithm to determine an updated network graph, (v) determine a constraint for the new data asset structure, (vi) based on applying the constraint to the updated network graph, determine a new data asset structure, (vii) output an indication of the new data asset structure, and (viii) generate a new data asset according to the new data asset structure.

### BACKGROUND

An increasing number of technology areas are becoming driven by data and the analysis of such data to develop insights. As usage, applications, and data volumes grow, there is a concurrently growing demand for technological approaches that can efficiently process, analyze, and derive insights from this data, enabling organizations to optimize operations and enhance customer experiences.

### OVERVIEW

Disclosed herein is new software technology generating new data asset structures in an intelligent and transparent way.

In one aspect, the disclosed software technology may take the form of a method to be carried out by a computing platform that involves (i) generating a network graph that encodes a representation of (a) a plurality of existing data assets stored by the computing platform, (b) respective relationships between the existing data assets, and (c) respective consumption activity, for each existing data asset, by one or more users of the computing platform, (ii) receiving, as input, an indication of one or more design parameters for a new data asset structure to be used for one or more new data assets, (iii) based on the one or more design parameters for the new data asset structure, selecting one or more network optimization algorithms to apply to the network graph, (iii) utilizing the selected one or more network optimization algorithms to determine an updated network graph, (iv) determining an indication of one or more constraints for the new data asset structure, (v) based on applying the one or more constraints to the updated network graph, determining a new data asset structure, (vi) outputting, to a client device associated with a user, an indication of the new data asset structure, and (vii) generating a new data asset according to the new data asset structure, the new data asset comprising data values from one or more of the existing data assets.

In some examples, the method may also involve, generating a decision record associated with the new data asset structure, the decision record comprising an indication of (i) the respective consumption activity, (ii) the one or more design parameters, and (iii) the one or more constraints, and outputting, to the client device associated with the user, an indication of the decision record.

Further, in some examples, generating the network graph may include generating the network graph to further encode a representation of a respective position of each of the one or more users within an organizational hierarchy of an organization.

Further, in some examples, the one or more network optimization algorithms may include one or more of a clustering algorithm, a partitioning algorithm, a centrality algorithm, or a label propagation algorithm.

Still further, the method may also involve, identifying, within the consumption activity, one or more action records associated with a given data field of one or more of the existing data assets, wherein the one or more action records indicates user activity that does not satisfy the one or more constraints, wherein determining the new data asset structure comprises determining the new data asset structure further based on the identified one or more action records.

Still further, in some examples, the network graph is a network multigraph.

Still further, the method may also involve adding the one or more new data assets to the plurality of existing data assets and generating a new network graph that encodes a representation of the plurality of existing data assets and the new data assets.

In another aspect, disclosed herein is a computing platform that includes at least one processor, at least one non-transitory computer-readable medium, and program instructions stored on the at least one non-transitory computer-readable medium that, when executed by the at least one processor, cause the computing platform to carry out the functions disclosed herein, including but not limited to the functions of the foregoing method.

In yet another aspect, disclosed herein is a non-transitory computer-readable medium that is provisioned with program instructions that are executable to cause a computing platform to carry out the functions disclosed herein, including but not limited to the functions of the foregoing method.

One of ordinary skill in the art will appreciate these as well as numerous other aspects in reading the following disclosure.

### BRIEF DESCRIPTION OF THE DRAWINGS

FIG. 1 is a simplified block diagram of an example network environment in which an example data platform may operate.

FIG. 2 is a simplified block diagram depicting an example software-based pipeline for generating a new data asset structure in accordance with the present disclosure.

FIG. 3A is a schematic diagram depicting an example set of existing data assets that form part of a network graph in accordance with the present disclosure.

FIG. 3B is a schematic diagram depicting an example of a new data asset having a new data asset structure based in part on the network graph shown in FIG. 3A.

FIG. 4 is a flow chart that illustrates one possible example of functionality for generating a new data asset structure in accordance with the present disclosure.

FIG. 5 is a simplified block diagram that illustrates some structural components that may be included in an example data platform.

FIG. 6 is a simplified block diagram that illustrates some structural components that may be included in an example client device.

### DETAILED DESCRIPTION

The following disclosure makes reference to the accompanying figures and several example embodiments. One of ordinary skill in the art should understand that such references are for the purpose of explanation only and are therefore not meant to be limiting. Part or all of the disclosed systems, devices, and methods may be rearranged, combined, added to, and/or removed in a variety of manners, each of which is contemplated herein.

Organizations in many different industries have begun to operate computing platforms that are configured to ingest, process, analyze, generate, store, and/or output data that is relevant to the businesses of those organizations, which are often referred to as “data platforms.” For example, a financial institution may operate a data platform that is configured to ingest, process, analyze, generate, store, and/or output data related to the financial institution's customers and their financial accounts, such as financial transactions data (among other types of data that may be relevant to the financial institution's business). As another example, a provider of a Software-as-a-Service (Saas) application may operate a data platform that is configured to ingest, process, analyze, generate, store, and/or output data that is created in connection with that SaaS application. As another example, an organization interested in monitoring the state and/or operation of physical objects such as industrial machines, transport vehicles, and/or other Internet-of-Things (IoT) devices may operate a data platform that is configured to ingest, process, analyze, generate, store, and/or output data related to those physical objects of interest. Many other examples are possible as well.

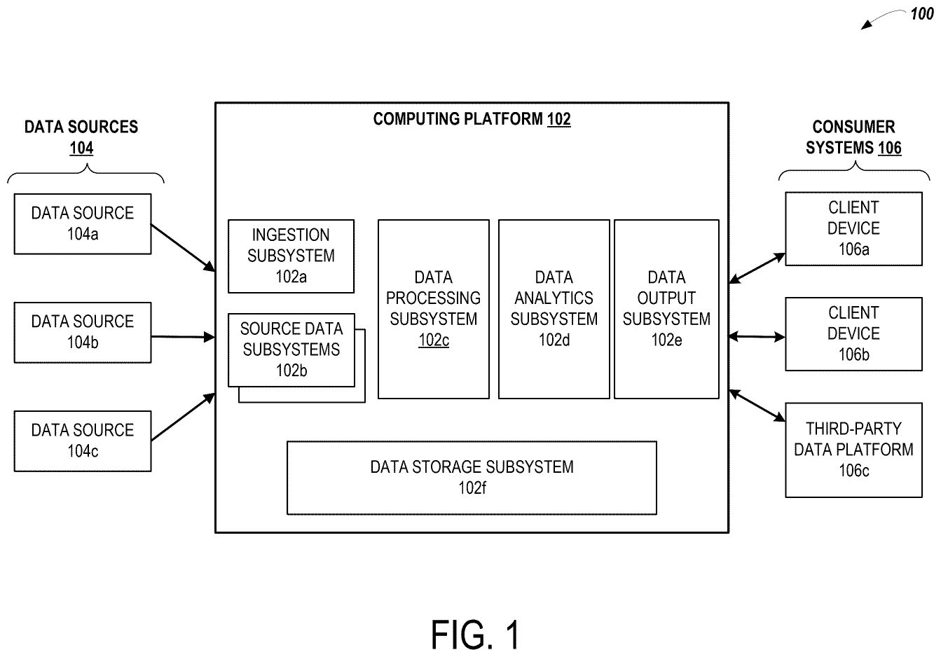

To illustrate with an example, FIG. 1 depicts a network environment 100 that includes at its core an example computing platform 102 that serves as a data platform for an organization, which may comprise a collection of functional subsystems that are each configured to perform certain functions in order to facilitate tasks such as data ingestion, data generation, data processing, data analytics, data storage, and/or data output. These functional subsystems may take various forms.

For instance, as shown in FIG. 1, the example computing platform 102 may comprise an ingestion subsystem 102a that is generally configured to ingest source data from a particular set of data sources 104, such as the three representative data sources 104a, 104b, and 104c shown in FIG. 1, over respective communication paths. These data sources 104 may take any of various forms, which may depend at least in part on the type of organization operating the example computing platform 102. For example, if the example computing platform 102 comprises a data platform operated by a financial institution, the data sources 104 may comprise computing devices and/or systems that generate and output data related to the financial institution's customers and their financial accounts, such as financial transactions data (e.g., purchase and/or sales data, payments data, etc.), customer identification data (e.g., name, address, social security number, etc.), customer interaction data (e.g., web-based interactions with the financial institution such as logins), and/or credit history data, among various other possibilities. In this respect, the data sources that generate and output such data may take the form of payment processors, merchant service provider systems such as payment gateways, point-of-sale (POS) terminals, automated teller machines (ATMs), computing systems at brick-and-mortar branches of the financial institution, and/or client devices of customers (e.g., personal computers, mobile phones, tablets, etc.), among various other possibilities. The data sources 104 may take various other forms as well.

Further, as shown in FIG. 1, the example computing platform 102 may comprise one or more source data subsystems 102b that are configured to internally generate and output source data that is consumed by the example computing platform 102. These source data subsystems 102b may take any of various forms, which may depend at least in part on the type of organization operating the example computing platform 102. For example, if the example computing platform 102 comprises a data platform operated by a financial institution, the one or more source data subsystems 102b may comprise functional subsystems that internally generate and output certain types of data related to customer accounts (e.g., account balance data, payment schedule data, etc.). The one or more source data subsystems 102b may take various other forms as well.

Further yet, as shown in FIG. 1, the example computing platform 102 may comprise a data processing subsystem 102c that is configured to carry out certain types of processing operations on the source data. These processing operations could take any of various forms, including but not limited to data preparation, transformation, and/or integration operations such as validation, cleansing, deduplication, filtering, aggregation, summarization, enrichment, restructuring, reformatting, translation, mapping, etc.

Still further, as shown in FIG. 1, the example computing platform 102 may comprise a data analytics subsystem 102d that is configured to carry out certain types of data analytics operations based on the processed data in order to derive insights, which may depend at least in part on the type of organization operating the example computing platform 102. For example, if the example computing platform 102 comprises a data platform operated by a financial institution, the data analytics subsystem 102d may be configured to carry out data analytics operations in order to derive certain types of insights that are relevant the financial institution's business, examples of which could include predictions of fraud or other suspicious activity on a customer's account and predictions of whether to extend credit to an existing or prospective customer, among other possibilities. The data analytics subsystem 102d may be configured to carry out any of numerous other types of data analytics operations as well.

Moreover, the data analytics operations carried out by the data analytics subsystem 102d may be embodied in any of various forms. As one possibility, a data analytics operation may be embodied in the form of a user-defined rule (or set of rules) that is applied to a particular subset of the processed data in order to derive insights from that processed data. As another possibility, a data analytics operation may be embodied in the form of a data science model that is applied to a particular subset of the processed data in order to derive insights from that processed data. In practice, such a data science model may comprise a machine learning model that has been created by applying one or more machine learning techniques to a set of training data, but data science models for performing data analytics operations could take other forms and be created in other manners as well. The data analytics operations carried out by the data analytics subsystem 102d may be embodied in other forms as well.

Referring again to FIG. 1, the example computing platform 102 may also comprise a data output subsystem 102e that is configured to output data (e.g., processed data and/or derived insights) to certain consumer systems 106 over respective communication paths. These consumer systems 106 may take any of various forms.

For instance, as one possibility, the data output subsystem 102e may be configured to output certain data to client devices that are running software applications for accessing and interacting with the example computing platform 102, such as the two representative client devices 106a and 106b shown in FIG. 1, each of which may take the form of a desktop computer, a laptop, a netbook, a tablet, a smartphone, or a personal digital assistant (PDA), among other possibilities. These client devices may be associated with any of various different types of users, examples of which may include individuals that work for or with the organization operating the example computing platform 102 (e.g., employees, contractors, etc.) and/or customers of the organization operating the example computing platform 102. Further, the software applications for accessing and interacting with the example computing platform 102 that run on these client devices may take any of various forms, which may depend at least in part on the type of user and the type of organization operating the example computing platform 102. As another possibility, the data output subsystem 102e may also be configured to output certain data to other third-party data platforms, such as the representative third-party data platform 106c shown in FIG. 1.

In order to facilitate this functionality for outputting data to the consumer systems 106, the data output subsystem 102e may comprise one or more Application Programming Interface (APIs) that can be used to interact with and output certain data to the consumer systems 106 over a data network, and perhaps also an application service subsystem that is configured to drive the software applications running on the client devices, among other possibilities.

The data output subsystem 102e may be configured to output data to other types of consumer systems 106 as well.

Referring once more to FIG. 1, the example computing platform 102 may also comprise a data storage subsystem 102f that is configured to store all of the different data within the example computing platform 102, including but not limited to the source data, the processed data, and the derived insights. In practice, this data storage subsystem 102f may comprise several different data stores that are configured to store different categories of data. For instance, although not shown in FIG. 1, this data storage subsystem 102f may comprise one set of data stores for storing source data and another set of data stores for storing processed data and derived insights. However, the data storage subsystem 102f may be structured in various other manners as well. Further, the data stores within the data storage subsystem 102f could take any of various forms, examples of which may include relational databases (e.g., Online Transactional Processing (OLTP) databases), NoSQL databases (e.g., columnar databases, document databases, key-value databases, graph databases, etc.), file-based data stores (e.g., Hadoop Distributed File System), object-based data stores (e.g., Amazon S3), data warehouses (which could be based on one or more of the foregoing types of data stores), data lakes (which could be based on one or more of the foregoing types of data stores), message queues, and/or streaming event queues, among other possibilities.

The example computing platform 102 may comprise various other functional subsystems and take various other forms as well.

In practice, the example computing platform 102 may generally comprise some set of physical computing resources (e.g., processors, data storage, etc.) that are utilized to implement the functional subsystems discussed herein. This set of physical computing resources take any of various forms. As one possibility, the computing platform 102 may comprise cloud computing resources that are supplied by a third-party provider of “on demand” cloud computing resources, such as Amazon Web Services (AWS), Amazon Lambda, Google Cloud Platform (GCP), Microsoft Azure, or the like. As another possibility, the example computing platform 102 may comprise “on-premises” computing resources of the organization that operates the example computing platform 102 (e.g., organization-owned servers). As yet another possibility, the example computing platform 102 may comprise a combination of cloud computing resources and on-premises computing resources. Other implementations of the example computing platform 102 are possible as well.

Further, in practice, the functional subsystems of the example computing platform 102 may be implemented using any of various software architecture styles, examples of which may include a microservices architecture, a service-oriented architecture, and/or a serverless architecture, among other possibilities, as well as any of various deployment patterns, examples of which may include a container-based deployment pattern, a virtual-machine-based deployment pattern, and/or a Lambda-function-based deployment pattern, among other possibilities.

As noted above, the example computing platform 102 may be configured to interact with the data sources 104 and consumer systems 106 over respective communication paths. Each of these communication paths may generally comprise one or more data networks and/or data links, which may take any of various forms. For instance, each respective communication path with the example computing platform 102 may include any one or more of point-to-point data links, Personal Area Networks (PANs), Local Area Networks (LANs), Wide Area Networks (WANs) such as the Internet or cellular networks, and/or cloud networks, among other possibilities. Further, the data networks and/or links that make up each respective communication path may be wireless, wired, or some combination thereof, and may carry data according to any of various different communication protocols. Although not shown, the respective communication paths may also include one or more intermediate systems, examples of which may include a data aggregation system and host server, among other possibilities. Many other configurations are also possible.

It should be understood that network environment 100 is one example of a network environment in which a data platform may be operated, and that numerous other examples of network environments, data platforms, data sources, and consumer systems are possible as well.

Many types of organizations rely on the types of data platforms shown in FIG. 1 for the creation, maintenance, and usage of organizational data as a key driver of business value. At the same time, such a data platform can also be a key driver of operational cost, as the expense for both cloud-based and on-premises solutions are directly related to the amount of storage and processing that are used. To address these needs, the structure of an organization's data assets should be designed in such a way that allows users to easily and efficiently access the information that they need, perhaps from multiple different data sources, to derive the insights they seek, all while being as computationally efficient as possible. Consider an example user workflow that involves three queries of an organization's data platform to retrieve data from three different source data assets, which the user then transforms in one or more ways to obtain a desired insight from the data. This workflow might be performed more quickly, from the user's perspective, if there were a single data asset having a redesigned data asset structure that included all of the disparate data, requiring only a single query to obtain. Further, the reduced number of queries resulting from the redesigned data asset structure may be more cost effective as well from a database perspective. Accordingly, the benefits of designing data asset structures that are easily usable to derive insights quickly and are also cost effective (e.g., based on query time) are significant.

However, the process of designing and/or redesigning data asset structures in this way, with a view toward both user needs and operational efficiency, requires significant technical expertise from data engineering and data modeling professionals. Moreover, as user needs change, data asset structures that were formerly useful may need to be updated. At large scale—e.g., for thousands of users and thousands of data assets with thousands of sub-structures within those data assets—the process of creating and maintaining effective data asset structures for an organization's data platform is challenging to complete manually, incurring substantial expenditures in both time and cost.

In addition, balancing several different objectives to design a particular data asset structure, including data platform characteristics, business domain knowledge, and design best practices presents additional challenges. When this type of data asset structure design is carried out by different individuals that are siloed from each other within a federated organization, it leaves room for gaps in consistency across different groups of data assets, which may be consumed by individuals across an entire organization despite being created separately. In addition, current solutions generally do not deviate from prescribed rules for data asset creation and therefore do not incorporate decision records from past data asset creation processes. These gaps, in turn, are lost opportunities to implement solutions that are better suited or more consistent with past decisions.

In view of these and other shortcomings associated with existing data processing solutions for large-scale data, the present disclosure provides a software-based pipeline that enables data asset structures to be intelligently designed based on the needs of current users as well as learned best practices. Further, the data asset structures discussed herein can be traceably modeled and designed, with the reasoning behind the designs explainable to end users based on their interactions with the organization's data assets. In particular, the workflow steps that led to a particular data asset structure are tracked in a consumable format, which may allow users to see how decisions relating to data asset structure design may have branched in different domains. In this way, an end user of the software-based pipeline discussed herein may be a consumer of both the newly created data asset structure as well as the reasoning behind decisions made during the creation. Unlike typical modeling workflows for data asset structures that are based on a set of static rules, the software-based pipeline discussed herein enhances the design workflow to be intelligently driven by the organization's operational data, while also allowing for a human in the loop.

The software-based pipeline can be used to design optimized data asset structures for analytical use based on the incorporation of information from multiple types of inputs, including user interactions with the organization's existing data assets, a set of one or more design parameters that may be used as guiding principles to prioritize different results, among others. Further, once a given data asset structure is implemented, the data assets created in accordance with the new structure may be monitored for changes in the consumption behavior to iteratively propose updated structures that better fit the new patterns. As an organization's businesses grow and evolve, the organization can leverage the software-based pipeline to optimize data asset creation processes, reducing potential redundancies and wasted effort. This can help reduce operational costs in these processes, enabling and accelerating data-driven workflows across the organization. Further, the transparency afforded by the new software-based pipeline can build trust in the accuracy and effectiveness of the organization's data processing systems.

At a high level, the disclosed software-based pipeline may initially involve a data gathering stage in which the existing data assets that are maintained by an organization, and information related to those existing data assets, are collected and encoded into a machine-readable knowledge base. For the purposes of this disclosure, a data asset may refer to a set of data—including one or more data values for one or more data fields—that is bounded in one or more ways that indicate the purpose of the data. For instance, a given data asset may include data that is bounded to a particular type of data (e.g., customer account information, credit card application information, transaction data for card purchases, fraud information, etc.), bounded to a particular time frame (e.g., monthly, yearly, etc.) and/or bounded to a particular department or line of business within an organization (e.g., deposit servicing, electronic banking, personal loans, etc.) among numerous other possibilities. In this regard, a given data asset may represent a unit of consumption for the underlying data, and there may be many different ways that the same data may be represented in differently structured data assets.

A given data asset may be updated regularly as new information is received by the data platform from the underlying data applications that generate the data. In some situations, for example, an organization may adjust what types of data may or may not be included in certain data assets (e.g., due to changing regulations or organizational policies). Further, a given data asset might include data from various different data sources (e.g., one or more data sources 104 and/or source data subsystems 102b). Moreover, although a given data asset may be presented to a user who queries the data asset (e.g., at a consumer system 106) as an assembled table or similar view that includes data in rows and/or columns, the underlying data itself that makes up the given data asset may be physically stored in multiple different locations (e.g., multiple locations within the data storage subsystem 102f). In this regard, a given data asset may have a fully or partially defined data asset structure. For instance, a given data asset may include data that exists in multiple sub-structures that collectively make up a higher-level data asset.

The machine-readable knowledge base of information related to an organization's existing data assets may be embodied in various forms. As one possibility, the information may take the form of a network graph that encodes each existing data asset as a node in the network graph, where each node may be connected to one or more other nodes by one or more edges that represent the various types of relationships between the existing data asset nodes. In this regard, both the nodes and edges of the network graph may include various attributes characterizing the particular node or edge. In some implementations, the network graph may take the form of a multigraph, which may include multiple edges between any two nodes. The network graph might alternatively take the form of a hypergraph, in which a single edge may connect more than two nodes. The knowledge base may take the form of other types of graphs as well. Further, although the examples discussed here will generally refer to the assembled knowledge base as a network graph, it should be understood that various other types of data structures may be utilized in addition to or as an alternative to a network graph.

The types of relationships that are encoded within the network graph as edges between existing data asset nodes may be direct or indirect relationships and may take various forms. As one possibility, one type of edge between nodes may indicate whether the existing data assets represented by the nodes originated from the same data source or related data sources. As another possibility, there may be logical relationships between the data fields in two or more existing data assets, which may be represented by edges in the network graph. For example, a first data asset may include one or more columns of data that indicate balance information for consumer credit card accounts for a given time period. A second data asset may include one or more columns that indicate transaction information (e.g., charges and payments) for the same consumer credit card accounts for the same given time period, such that summing the transaction data in the columns of the second data asset may equal the balance data in the columns of the first data asset. Accordingly, the relationship between these particular data fields may be encoded within the network graph as an edge between the two nodes representing the first and second data assets. Other types of logical relationships are also possible and may be encoded as edges within the network graph as well.

Another type of information related to the organization's existing data assets that may be encoded within the network graph is consumption activity by consumers of the data platform. In this regard, consumption activity for a given data asset may refer to transactions within the data platform that were carried out by one or more consumers and generally reflects how consumers (e.g., users and/or other systems) interacted with the given data asset. This information may be sourced from system logs for the data platform and may be incorporated into the network graph as additional nodes and/or edges.

The consumption activity information may take various forms, depending on the types of interactions carried out by users. As one possibility, the consumption activity information may represent user requests to create, view, update and/or delete a given data asset. Further, the consumption activity may include information related to users requests to transform data within a given data asset such as requests to split data from a single column or data asset into multiple columns, requests to merge data from multiple different columns within one or more data assets (e.g., merging columns form two different data assets) into fewer columns, requests to round numerical values in one or more columns of a given data asset, among various other possibilities. Further, the consumption activity information encoded within the network graph may include counts reflecting the number of times each of the logged interactions occurred within a given time period. Further, the consumption activity information may identify the different platforms and/or user applications that are used to consume and/or interact with the organization's data assets, including how these interactions may differ.

Still further, the network graph may also incorporate information that characterizes the respective users associated with each request in the consumption activity discussed above. In particular, for a given user request that is logged and added to the network graph as consumption activity, the request may additionally indicate a position of the requesting user within an organizational hierarchy (e.g., within a given department, etc.) of the organization that operates the data platform. This information may be obtained from an organizational directory, such as a directory that employes a lightweight directory access protocol (LDAP). This additional data may enrich the information within the network graph by providing some indication of the degree of similarity between different user requests (e.g., if requests for a given data asset are made by similarly-situated users) and/or how widespread the usage of a given data asset is across the organization (e.g., if requests for given data asset are made by users positioned in many different areas of the organizational hierarchy). Further, as will be appreciated from FIG. 1 and the discussion above, some consumption activity related to the existing data assets in the network graph may take the form of automated requests that originate from a given computing system, such as a consumer system 106 or another system of the data platform. In these cases, the requesting computing system may be associated with a given user or organizational structure (e.g., a given department) within the organizational hierarchy, and this association information may be encoded within the consumption activity information.

It should be understood that various other types of information related to a set of existing data assets are also possible in addition to those discussed above, and that these other types of information may be incorporated into a network graph in a similar manner.

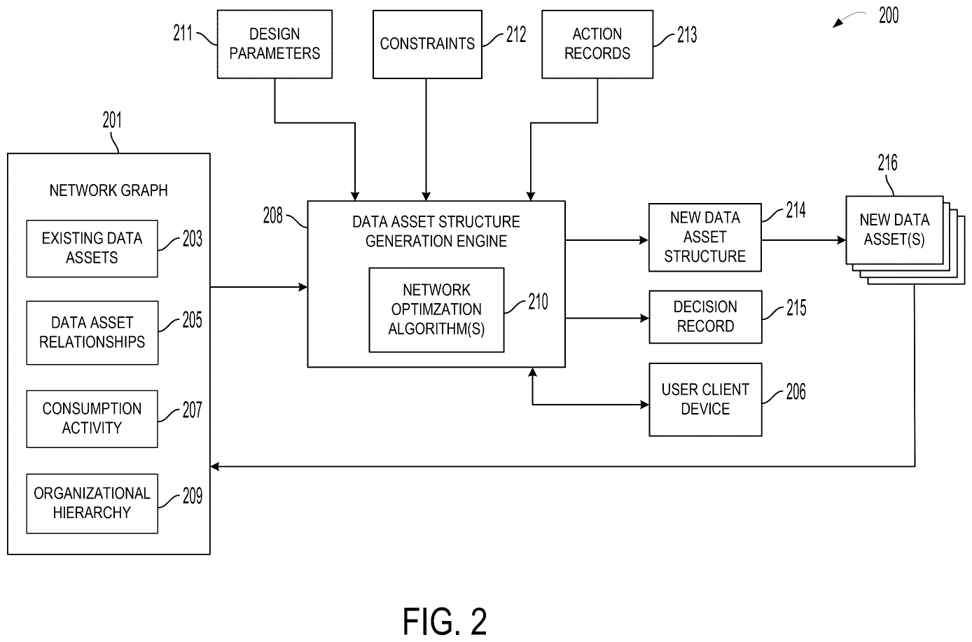

Turning now to FIG. 2, a block diagram of an example software-based pipeline 200 for generating a new data asset structure to be used for one or more data assets is shown. In FIG. 2, the software-based pipeline 200 is generally depicted as a set of inputs to and outputs from a data asset structure generation engine 208. In practice, the data asset structure generation engine 208 may be encoded in the form of program instructions that are executable by one or more processors of one or more computing platforms. For purposes of illustration, the example software-based pipeline 200 is described as being installed on and executed by the computing platform 102 of FIG. 1, but it should be understood that the example software-based pipeline 200 may be installed on and executed by any one or more computing platforms that are capable of performing the example operations of the example software-based pipeline 200, and in some cases, different components of the example software-based pipeline 200 may be executed by different computing platforms that communicate with one another via a network-based communication path. Further, it should be understood that the example software-based pipeline 200 is merely described in this manner for the sake of clarity and explanation and that the example operations may be implemented in various other manners, including the possibility that operations may be added, removed, rearranged into different orders, combined into fewer blocks, and/or separated into additional blocks depending upon the particular embodiment.

Further, it should be understood that the data asset structure generation engine 208 shown in FIG. 2 may be a subsystem of the higher-level functional subsystems described and shown with reference to FIG. 1 or could be separate from those higher-level functional subsystems. For example, the data asset structure generation engine 208 may be a subsystem of one or both of the data processing subsystem 102c and the data analytics subsystem 102d of FIG. 1. Other configurations are also possible.

As shown in FIG. 2, a first input to the data asset structure generation engine 208 in the pipeline 200 is the network graph discussed above that encodes a representation of existing data assets that are maintained by an organization along with information related to those existing data assets. Accordingly, a schematic representation of the network graph 201 is depicted in FIG. 2 that includes a representation of a set of existing data assets 203, a representation of data asset relationships 205 between the existing data assets 203, a representation of consumption activity data 207 for the existing data assets 203, and a representation of how the consumers responsible for the consumption activity data 207 fit within an organizational hierarchy 209 of the organization that implements the software-based pipeline 200.

A second input to the software-based pipeline 200 includes an indication of one or more design parameters 211 that the data asset structure generation engine 208 may utilize as design principles when determining the new data asset structure. The one or more design parameters 211 may represent a set of specific, parameterized goals (e.g., representing best practices, user preferences, etc.) to be used as inputs to an optimization process during data asset structure creation. The design parameters 211 may take various forms. As one example, a design parameter 211 may involve prioritizing the lowest possible cost resulting from the new data asset structure. As mentioned above, an organization's operational costs in relation to data storage and computation resources are directly affected by the number of queries and the complexity of each query, which can have an impact on query time. Accordingly, a relatively simpler data asset structure with fewer data fields and that requires fewer queries to populate with data may be more cost effective than an alternative data asset structure that has more data fields and requires more queries to populate. Along the same lines, certain types of queries, such as a MERGE query, may be more computationally expensive than others, and thus a more specific example of a design parameter 211 directed to cost savings may be to minimize MERGE queries when defining the new data asset structure.

As another example, a different design parameter 211 may involve prioritizing the fewest queries to insight provided by the new data asset structure. As mentioned above, an organization's data assets are used as a key driver of business value, by deriving insights from such data. Depending on the insight that is to be derived, this may involve applying one or more data processing operations to the data from one or more data assets (e.g., one or more data transformations, filtering, summarization, etc.). Accordingly, a new data asset structure that is designed based on this type of design parameter may incorporate one or more data processing operations that are applied to the underlying data that populates the new data asset structure, in order to present a more fully-developed (e.g., final) insight. This, in turn, may require less user interaction with the new data assets that are created in order to obtain the desired insight, at the expense of perhaps increasing the size and/or complexity of the new data asset structure and thereby introducing additional cost.

The design parameters 211 may take various other forms and may represent various other parameterized goals that may be applied during the creation of a new data asset structure. In some implementations, users may be enabled to define new design parameters 211 that are specific to the particular needs of their department within the organization. Other examples are also possible.

In practice, a user of the software-based pipeline 200 may select one or more of the design parameters 211 to be used as inputs to the data asset structure generation engine 208. In this regard, the design parameters 211 may be stored by the computing platform 102 (e.g., as entries in a database) and then presented to a user for selection. Alternatively, one or more design parameters 211 may be used by default by an entire organization, or by particular departments within an organization based on the needs of each particular department. In these situations, the design parameters 211 may be applied automatically by the data asset structure generation engine 208 unless they are manually adjusted by a user. The design parameters 211 may be selected as input in other ways as well.

After the indication of one or more design parameters 211 are received, the data asset structure generation engine 208 may analyze the one or more design parameters 211 to determine their relevance to the network graph 201. In this regard, a given design parameter 211 may be more or less relevant to the network graph 201 based on the information contained within the network graph 201. For example, the data asset structure generation engine 208 may determine than a given design parameter 211 that prioritizes minimizing a particular type of query may be relatively less relevant to the network graph 201 if the consumption activity data 207 encoded within the network graph 201 contains relatively few instances of such queries being performed by users. Alternatively, the data asset structure generation engine 208 may determine that a design parameter 211 that prioritizes the fewest queries to insight may be relatively more relevant to the network graph 201 is the consumption activity data 207 encoded with in the network graph 201 indicates that users are frequently performing multiple queries and transformations across the existing data assets within the network graph 201 to derive particular insights. Other examples are also possible.

In turn, these measures of relevance may be recorded by the data asset structure generation engine 208 and included in a decision record that is produced as output, as discussed further below.

In addition to determining the relevance of the design parameters 211, the data asset structure generation engine 208 may determine the relevance of a set of network optimization algorithms 210 that may be applied to the network graph 201 to derive insights about the relationships and consumption activity patterns within the network graph 201. In this regard, and as discussed further in the examples below, the relevance of a given network optimization algorithm may be determined based at least in part on the design parameters 211 that are used as input. Based on the relevance of the respective network optimization algorithms, the data asset structure generation engine 208 may select one or more of the network optimization algorithms 210 to be applied to the network graph 201.

In some implementations, before applying the one or more network optimization algorithms 210, the computing platform 102 may apply one or more transformations to the network graph 201 in order reformat the network graph 201 to be used as input for a given one or more of the selected network optimization algorithms 210. Accordingly, although the examples that follow will generally refer to applying one or more network optimization algorithms 210 to the network graph 201, it should be understood that the one or more network optimization algorithms 210 may be applied to a transformed and/or reformatted version of the network graph 201.

The network optimization algorithms 210 may take various forms. As one possibility, the network optimization algorithms 210 may include one or more clustering algorithms, partitioning algorithms, and/or community detections algorithms that may be applied to break the network graph 201 into related structures of data. In this regard, the relationship between the notes and edges within the network graph 201 may be assessed on one or both of the similarity between the existing data assets in the network graph 201 or the similarity of the consumption activity patterns associated with those existing data assets. Further, the granularity with which the elements of the network graph 201 are grouped together or separated into different clusters may be driven in part by the design parameters 211. For example, breaking the network graph 201 into more numerous, smaller clusters may be relatively more cost effective and may be favored if that type of design parameter is to be prioritized.

As another possibility, the network optimization algorithms 210 may include one or more k-core algorithms or other centrality algorithms that may be applied to determine whether certain groups of existing data assets within the network graph 201 are higher priority based on their data asset relationships and associated consumption activity. In this regard, the selection and application of one or more centrality algorithms may be driven in part by the design parameters 211. For example, identifying the most tightly connected portions of the network graph 201 may be useful to identify the existing data assets that are queried most frequently to derive insights, which may be prioritized in instances where the new data asset structure is intended to provide such insights, as discussed above.

As yet another possibility, the network optimization algorithms 210 may include one or more label propagation algorithms that may be applied to probabilistically identify existing data assets within the network graph 201 that are not grouped in a cluster or partition for inclusion into a community to which it is mostly like to be related. This in turn may assist the data asset structure generation engine 208 in determining whether to include data fields from these types of existing data assets into a new data assets structure, e.g., in scenarios where the new data asset structure is designed to provide more comprehensive insights.

Various other types of network optimization algorithms 210 are also possible.

After selecting the one or more network optimization algorithms 210 based in part on the design parameters 211, the data asset structure generation engine 208 may apply the one or more network optimization algorithms 210 and to the network graph 201 and thereby determine an updated network graph that provides insights into the relationships between existing data assets and consumption activity patterns within the network graph 201. Based on these insights the data asset structure generation engine 208 may propose a candidate data asset structure.

A hypothetical example will now be discussed that implements the steps above in the context of an organization that offers financial services. In this hypothetical example, assume that an objective of the software-based pipeline 200 is to design a new data asset structure for analytical user consumption that will enable users of the organization to better understand the likelihood that credit card customers will pay outstanding card balances. As discussed above, a network graph 201 may be generated by the organization that encodes various information related to the existing data assets 203 that are stored by the computing platform 102.

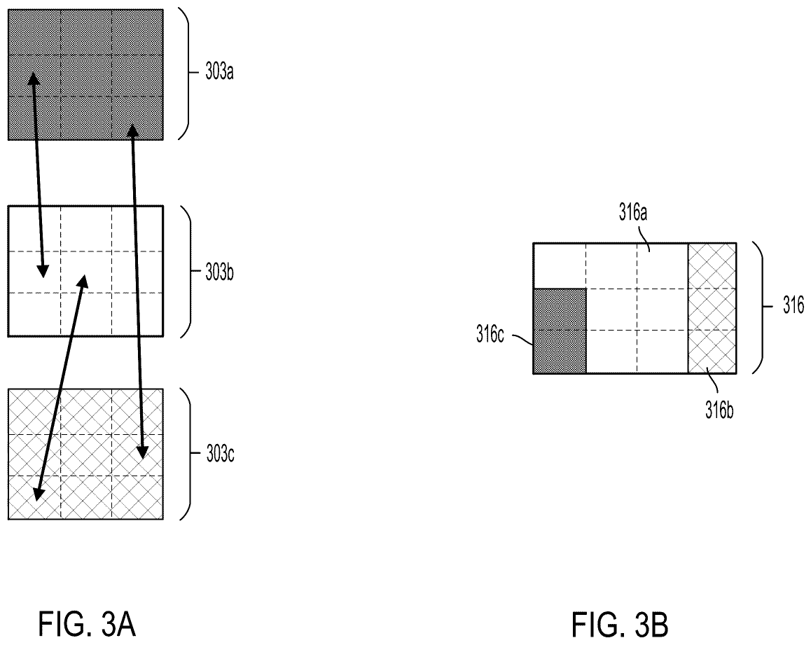

FIG. 3A depicts an example set of existing data assets that form nodes in a portion of the network graph 201, including a first data asset 303a labeled Data Asset A, a second data asset 303b labeled Data Asset B, and third data asset 303c labeled Data Asset C. Each of these data assets may include different types of information, obtained from different data sources, related to the organization's operations. In this example, Data Asset A may include customer information at a point in time that corresponds to the time of the credit card application. Data Asset B may include credit bureau information that includes tradeline data for other credit accounts that the customer holds, as well as unpaid and unpaid balance information for those accounts. Data Asset C may include credit card transaction information including charges and payments.

FIG. 3A also illustrates the respective relationships between these existing data assets, which are depicted as edges interconnecting the assets. As noted above, the types of data asset relationships 205 encoded within the network graph 201 may take various forms. For instance, the edges between Data Asset A, which includes customer information, and the other two data assets may represent that Data Asset B includes credit bureau information and Data Asset C includes transaction information related to the same customer or customers referenced in Data Asset A. Further, the edge between Data Asset B and Data Asset C may indicate that certain data within Data Asset B may be reconciled with certain corresponding data within Data Asset C. For instance, the transaction information for payments in Data Asset C, for a given customer during a given time period, should be equal to the credit bureau information indicating a paid balance in Data Asset B, for the same customer during the same time period. Similarly, summing all transaction data (e.g., both charges and payments) in Data Asset C, for a given customer during a given time period, should be equal to the credit bureau information indicating an unpaid balance in Data Asset B, for the same customer during the same time period.

Other relationships between each of the existing data assets shown in FIG. 3A are also possible. In this regard, additional relationships between two of the existing data assets may be represented by additional, parallel edges to those already shown in FIG. 3A, producing a multigraph network structure as mentioned above.

In addition to the relationships between existing data assets, the portion of the network graph 201 shown in FIG. 3A may also encode a representation of the consumption activity related to the illustrated data assets. Further, this consumption activity may include, for each instance of consumption activity generated by a user, an indication of the user's position within the organization's organizational hierarchy. In the example shown in FIG. 3A, the consumption activity may indicate that twenty different users, spread across three different departments within the organization, made queries accessing Data Asset A and Data Asset B together, as well as queries accessing Data Asset B and Data Asset C together, whereas only one user made queries accessing Data Asset A and Data Asset C together.

Based on the information encoded within the network graph 201, the data asset structure generation engine 208 may select and apply a clustering algorithm (among other possible network optimization algorithms 210) that groups the existing data assets discussed above based on their similarity. For instance, based on the frequency with which data from Data Asset B is being accessed to separately derive insights in combination with data from either Data Asset A or from Data Asset C, the clustering algorithm may determine a relatively high likelihood that Data Asset A and Data Asset C should be grouped within the same cluster, even though data from these two data assets is not frequently accessed in combination with each other. Accordingly, the data asset structure generation engine 208 may apply a label to each of Data Assets A, B, and C that identifies them as members of the same cluster. In some implementations, the result of the clustering algorithm may include in its grouping decisions a probability (e.g., expressed as a percentage) that conveys the degree of similarity that a given data asset has with a given cluster. Further, a user may review who may accept or reject the a given output of the clustering algorithm For instance, a user may determine that a data asset that was determined to be similar to other data assets in a given cluster is not similar, and reject the label assignment determined by the clustering algorithm. These types of human-in-the-loop inputs may be recorded in a decision record for the data asset structure, as discussed in further detail below. Other examples are also possible.

This clustering information for Data Assets A, B, and C, as well as other network insights that may be derived from the application of one or more other network optimization algorithms, may form a portion of the updated network graph, which the data asset structure generation engine 208 may use to propose a candidate data asset structure. For instance, the candidate data asset structure may include data fields (e.g., one or more columns) from Data Asset A, data fields from Data Asset B, and data fields from Data Asset C.

In some implementations, the candidate data asset structure may be further refined based on additional inputs to the data asset structure generation engine 208, such as the constraints 212 and action records 213 shown in FIG. 2 and discussed in further detail below. However, in some other implementations, the candidate data asset structure may serve as one of the final outputs of the software-based pipeline 200, in the form of a new data asset structure 214. For instance, the candidate data asset structure may be presented to a user via the user client device 206 shown in FIG. 2, along with a decision record 215 that explains the design parameters 211 that were used. Further, the decision record 215 may include a recommendation, determined by the data asset structure generation engine 208, that no other constraints or action records are application to the candidate data asset structure. Accordingly, the user may select the candidate data asset structure to be used as the new data asset structure 214. Thereafter, the new data asset structure 214 may be used to generate one or more new data assets 216 in accordance with the new data asset structure 214.

One possible example of a data asset created in accordance with the candidate data asset structure is shown in FIG. 3B, which depicts a schematic representation of a data asset 316 that includes data 316a from Data Asset A, data 316b from Data Asset B, and data 316c from Data Asset C. In this way, the data asset 316 may be consumed by users seeking multiple different types of insights from the underlying data, leading to fewer individual queries that might otherwise be made to determine these insights separately.

Returning to FIG. 2, additional features of the software-based pipeline 200 involving refinement of the network graph data based on additional inputs to the data asset structure generation engine 208 will now be described. One such additional input may take the form of one or more constraints 212. In this regard, a constraint may refer to a transformation or other action that should be applied to certain types of data, but which may not be directly encoded within the network graph 201 as a relationship between existing data assets. As one example, a given data asset may include data values for a summary statistic in a first column and time window demarcations in second and third columns that mark the start and end of the time period for which the summary applies. A constraint related to this given data asset may dictate that the first column should not be separated from the second and third columns, as they include necessary data that underpins the data in the first column. As another example, a given data asset may include a data field that includes customer name information including a customer's full name. A constraint related to this given data asset may dictate that the name information data field should be split into three separate data fields that respectively including (i) the customers first name and middle name or initial, (ii) last name, and (iii) any titles or suffixes included in the original data field. As yet another example, a constraint may dictate a rounding logic that is to be used for numerical data fields of a given type, perhaps across several different types of data assets. Numerous other types of constraints are also possible.

As noted above, constraints of this type may not be directly encoded within the network graph 201 as a relationship between existing data assets. Rather, the one or more constraints 212 may be determined by referencing a knowledge base that stores this type of information (e.g., as a set of best practices). Additionally, or alternatively, the data asset structure generation engine 208 may infer one or more constraints based on the consumption activity data 207 encoded within the network graph 201. In this regard, the consumption activity data 207 may indicate the frequency with which certain actions are taken with respect to the same or similar data (e.g., how often a transformation is performed, how often a rounding logic is applied, etc.).

Accordingly, the data asset structure generation engine 208 may determine an indication of one or more constraints 212 to be used as input for the software-based pipeline 200. In some implementations, the data asset structure generation engine 208 may automatically apply the one or more constraints 212 to the updated network graph that results from application of the one or more network optimization algorithms 210, as discussed above. For instance, if the data asset structure generation engine 208 determines a relatively high probability (e.g., higher than a threshold probability) that a given constraint is applicable to the design of the new data asset structure in question, the given constraint may be applied without user review. Alternatively, the data asset structure generation engine 208 may cause the one or more constraints 212 to be presented to a user via the user client device 206 for review and consideration. For instance, the one or more constraints 212 may be presented to a user for review in all instances, or in instances where the data asset structure generation engine 208 is not confident enough in the applicability of a given constraint to apply it automatically. Other implementations are also possible, including examples in which some constraints are applied automatically and some are presented as recommendations for user review.

In view of the above, it will be appreciated that in some cases, a given constraint may run counter to one or more design parameter 211 that are being used by the data asset structure generation engine 208. For instance, a design parameter 211 that prioritizes reduced cost would generally not favor the splitting of a single data field into three data fields, as suggested above in the example constraint relating to customer names. However, constraints may reflect more specific business logic that is applied based on user knowledge in a given scenario and will generally supersede the design parameters 211 where there are conflicts. Accordingly, constraints 212 are encoded proactively into the new data asset structure that is determined by the data asset structure generation engine 208.

Another type of input that the data asset structure generation engine 208 may utilize may include one or more action records 213, as shown in FIG. 2. The one or more action records 213 may represent individual instances of user actions within the consumption activity data 207 that are related to a given type of data. In particular, the action records 213 may indicate an indication of user actions that deviated from expected behaviors, such as actions that were contrary to a typical best practice or constraint. As one example, the data asset structure generation engine 208 may apply the constraint discussed above related to splitting a customer name data field into three separate data fields. However, the data asset structure generation engine 208 may also identify, within the consumption activity data 207, one or more instances in which a user merged the three separated data fields into a single data field, or did not separate them in the first place.

Similar to the constraints 212 discussed above, the data asset structure generation engine 208 may cause the one or more action records 213 to be presented to a user via the user client device 206 for review and consideration, either in conjunction with the one or more recommended constraints 212 or as a subsequent step after the constraints have already been considered. In this regard, the data asset structure generation engine 208 may provide a recommendation for whether the action record is relevant to the new data asset structure that is being designed. For example, the data asset structure generation engine 208 may determine that the example action record 213 discussed above related to the customer name field corresponds to a user request for data relating to merchant customers of the financial institution, in which the name field represents a business entity name for the merchant customer, rather than a first name, last name, etc. typically found with customers who are individual persons. Accordingly, the data asset structure generation engine 208 may determine whether the new data asset structure that is being designed involves any merchant customer data, and if so, may recommend to the user that the constraint 212 related to splitting the customer name data field not be applied to the merchant customer data.

Numerous other types of action records 213 are also possible. Further, in some implementations, if the data asset structure generation engine 208 has high enough confidence in the likelihood that a given action record 213 is relevant to the new data asset structure being designed, the data asset structure generation engine 208 may update the new data asset structure accordingly.

Based on applying the one or more constraints 212 and/or the one or more action records 213 to the updated network graph, the data asset structure generation engine 208 may output the new data asset structure 214, as shown in FIG. 2. This, in turn, may then serve as the basis for the computing platform 102 to generate one or more new data assets 216 according to the new data asset structure. These new data assets 216, which includes data from one or more of the existing data assets 203, intelligently selected via the software-based pipeline 200, may allow users to quickly obtain insights from the organization's data. Further, the software-based pipeline 200 allows for the new data asset structure 214 to be generated efficiently, without the significant costs that may be involved with developing a similar data asset structure manually.

In addition, the data asset structure generation engine 208 may generate and output a decision record 215. The decision record 215 may include an indication of the various factors that contributed to the design of the new data asset structure 214, and in this way may generally explain the reasons why the new data asset structure 214 was designed the way that it was. For example, the decision record 215 may include an indication of the constraints 212 and action records 213 that were applied, include those that were applied automatically as well as those that were presented to a user and then accepted or rejected. Further, the decision record 215 may include an indication of the one or more design parameters 211 that were used by the data asset structure generation engine 208 to guide the design. Still further, the decision record 215 may include an indication of the consumption activity data 207 that was relevant to the design. For instance, a decision record 215 for the example discussed above in FIGS. 3A-3A may include an indication of the usage of Data Assets A and B together, along with usage of Data Assets B and C and together.

In this way, the decision record 215 may provide transparency to the data asset structure design process, which may allow users to better understand the reasoning behind the new data asset structure 214. For instance, the decision record 215 may provide an image of the entire workflow that led to the creation of the new data asset structure, including when human input entered the decision making. Moreover, this type of information is easy to access and consume via the decision record 215. This transparency, in turn, may facilitate review and update of the new data asset structure 214 over time as the organization's existing data assets are updated. This can be particularly useful in a large organization with many users spread across different departments. In these cases, while the design parameters used within the software-based pipeline 200 may be similar, the execution of the pipeline may vary based on the different consumption of data assets and different constraints that are particular to a given department. Nonetheless, useful structural improvements to a set of existing data assets may be applied in other contexts, if the reasons why the structural improvements were implemented can be reviewed by users.

Referring again to FIG. 2, it will be appreciated that the new data assets 216 that are created in accordance with the new data asset structure 214 may be added to the set of existing data assets 203 that are used to construct the network graph 201. In this regard, the computing platform 102 will log user activity with respect to the new data assets 216, which may be reflected as consumption activity in a new version of the network graph. This new version of the network graph may be used as input to the software-based pipeline 200, and so on. Thus, the software-based pipeline 200 may be used iteratively, with the output being used to refine the input data.

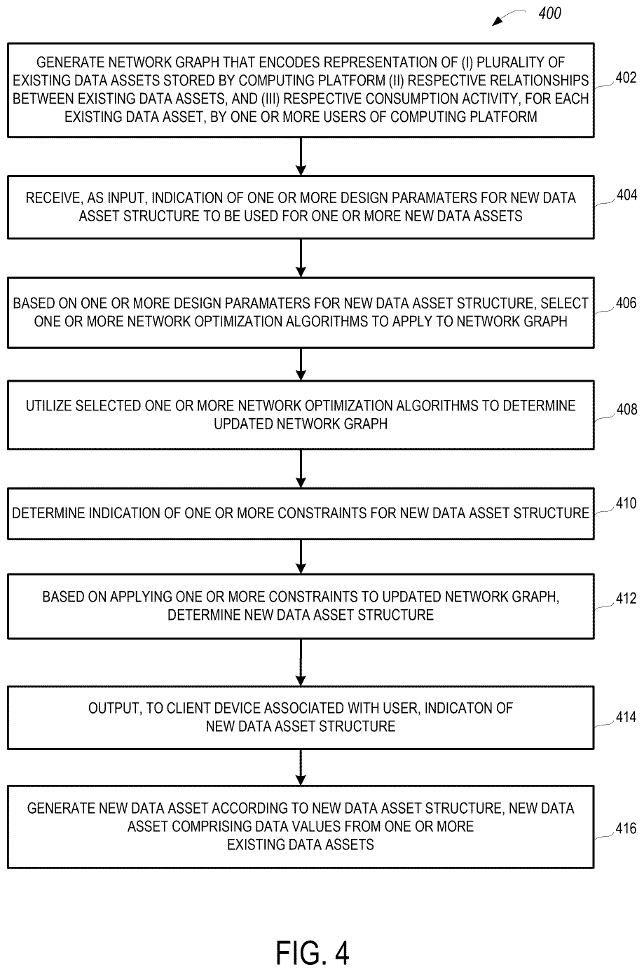

One possible example of functionality 400 that may be carried out in accordance with the disclosed technology will now be described with reference to the flow chart of FIG. 4. In practice, the functionality 400 of FIG. 4 may be encoded in the form of program instructions that are executable by one or more processors of a computing platform, and for purposes of illustration, the functionality 400 of FIG. 4 is described as being carried out by the computing platform 102 of FIG. 1, but it should be understood that the functionality 400 of FIG. 4 may be carried out by any one or more computing platforms that are capable of being installed with software for performing the functions described below. Further, it should be understood that the functionality 400 of FIG. 4 is merely described in this manner for the sake of clarity and explanation and that the example may be implemented in various other manners, including the possibility that functions may be added, removed, rearranged into different orders, combined into fewer blocks, and/or separated into additional blocks depending upon the particular example.

As shown in FIG. 4, the computing platform 102 may begin at block 402 by generating a network graph that encodes a representation of a plurality of existing data assets stored by the computing platform. As discussed above, the network graph may additionally encode a representation of respective relationships between the existing data assets. Still further, the network graph may encode an indication of respective consumption activity, for each existing data asset, by one or more users of the computing platform.

At block 404, the computing platform 102 may receive, as input, an indication of one or more design parameters for a new data asset structure to be used for one or more new data assets. For example, the computing platform 102 may receive an indication of one more design parameters from a client device. In this regard, the design parameters may be pre-defined or defined by a user of the client device, as generally discussed above.

At block 406, the computing platform 102 may select one or more network optimization algorithms to apply to the network graph. For example, the computing platform 102 may select the one or more network optimization algorithms based on the one or more design parameters for the new data asset structure. The one or more network optimization algorithms may take various forms, including those mentioned above as well as other examples. In some implementations, the computing platform 102 may receive user input via a client device regarding the one or more network optimization algorithms that are selected. For example, a user may reject usage of a network optimization algorithm that was initially identified by the computing platform 102, and/or suggest usage of a network optimization algorithm that was not suggested by the computing platform. A user may refine the selection of the one or more network optimization algorithms in other ways as well.

Thereafter, at block 408, the computing platform 102 may utilize the selected one or more network optimization algorithms to determine an updated network graph. Further, as noted above, the computing platform 102 may receive user input refining the results of the one or more network optimization algorithms. Accordingly, the updated network graph may be generated based on a combination of user input as well as outputs from the one or more network optimization algorithms.

At block 410, the computing platform 102 may determine an indication of one or more constraints for the new data asset structure. As noted above, the indication of the one or more constraints may be received as user input via a client device. For example, the user may indicate one or more constraints that are defined in a knowledge base, or the user may define a given constraint that is to be applied to the new data asset structure. Still further, the computing platform 102 may infer one or more constraints based on the consumption activity data 207 encoded within the network graph 201, as discussed above.

At block 412, the computing platform 102 may determine a new data asset structure based on applying the one or more constraints to the updated network graph. In addition, the computing platform 102 may further refine the updated network graph by applying one or more action records, as mentioned above. For example, the computing platform 102 may identify the one or more activity records within the consumption activity data, among other possibilities. Further, the computing platform 102 may receive user input regarding both the constraints and the action records.

At block 414, the computing platform 102 may output an indication of the new data asset structure to a client device associated with a user. In addition, the computing platform 102 may output a decision record, as discussed above with respect to FIG. 2, that includes a record of the workflow decisions that led to the creation of the new data asset structure. The user may accept or reject, in whole or in part, the new data asset structure, perhaps after reviewing the workflow decisions contained in the decision record. Accordingly, the computing platform 102 may receive, from the client device, an indication that the user accepted or rejected the new data asset structure.

At block 416, the computing platform 102 may generate a new data asset according to the new data asset structure. For example, after the new data asset structure is approved for production by a user, the user may execute a command to generate one or more new data assets using the new data asset structure. As noted above, the new data asset may include data values from one or more of the existing data assets.

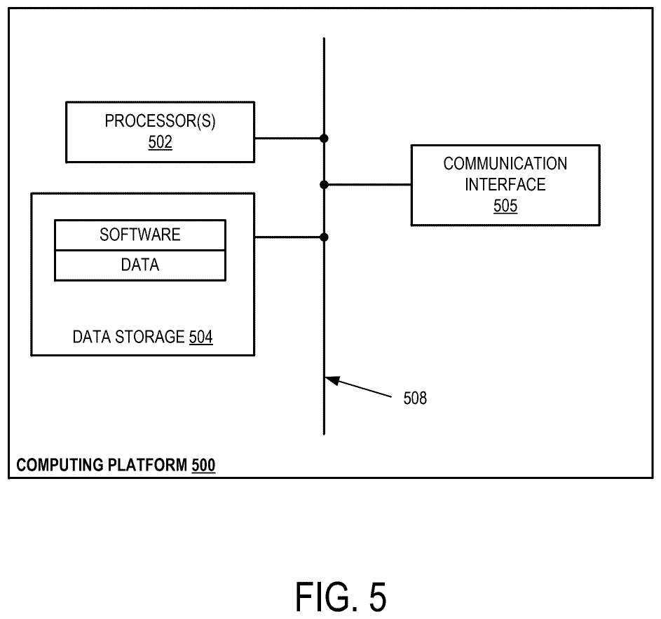

Turning now to FIG. 5, a simplified block diagram is provided to illustrate some structural components that may be included in an example computing platform 500. For example, computing platform 500 could serve as the computing platform 102 shown in FIG. 1 and may be configured to carry out any of the various functions disclosed herein—including but not limited to the functions described in connection with FIGS. 2-10. At a high level, computing platform 500 may generally comprise any one or more computer systems (e.g., one or more servers) that collectively include at least a processor 502, data storage 504, and a communication interface 506, all of which may be communicatively linked by a communication link 508 that may take the form of a system bus, a communication network such as a public, private, or hybrid cloud, or some other connection mechanism. Each of these components may take various forms.

For instance, processor 502 may comprise one or more processor components, such as general-purpose processors (e.g., a single-or multi-core microprocessor), special-purpose processors (e.g., an application-specific integrated circuit or digital-signal processor), programmable logic devices (e.g., a field programmable gate array), controllers (e.g., microcontrollers), and/or any other processor components now known or later developed. In line with the discussion above, it should also be understood that processor 502 could comprise processing components that are distributed across a plurality of physical computing devices connected via a network, such as a computing cluster of a public, private, or hybrid cloud.

In turn, data storage 504 may comprise one or more non-transitory computer-readable storage mediums, examples of which may include volatile storage mediums such as random-access memory, registers, cache, etc. and non-volatile storage mediums such as read-only memory, a hard-disk drive, a solid-state drive, flash memory, an optical-storage device, etc. In line with the discussion above, it should also be understood that data storage 504 may comprise computer-readable storage mediums that are distributed across a plurality of physical computing devices connected via a network, such as a storage cluster of a public, private, or hybrid cloud that operates according to technologies such as AWS for Elastic Compute Cloud, Simple Storage Service, etc.

As shown in FIG. 5, data storage 504 may be capable of storing both (i) program instructions that are executable by processor 502 such that the computing platform 500 is configured to perform any of the various functions disclosed herein (including but not limited to any the functions described in connection with FIG. 2-4), and (ii) data that may be received, derived, or otherwise stored by computing platform 500.

Communication interface 505 may take the form of any one or more interfaces that facilitate communication between computing platform 500 and other systems or devices. In this respect, each such interface may be wired and/or wireless and may communicate according to any of various communication protocols, examples of which may include Ethernet, Wi-Fi, Controller Area Network (CAN) bus, serial bus (e.g., Universal Serial Bus (USB) or Firewire), cellular network, and/or short-range wireless protocols, among other possibilities.

It should be understood that computing platform 500 is one example of a computing platform that may be used with the embodiments described herein. Numerous other arrangements are possible and contemplated herein. For instance, other computing systems may include additional components not pictured and/or more or less of the pictured components.

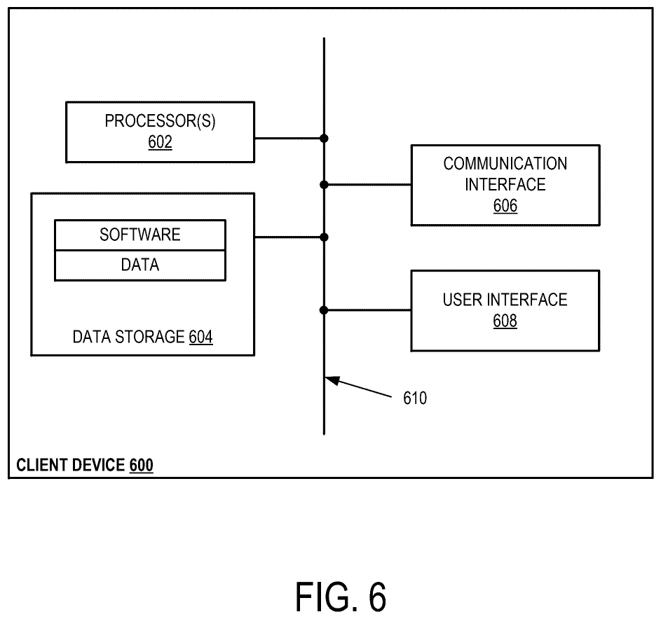

Turning now to FIG. 6, a simplified block diagram is provided to illustrate some structural components that may be included in an example client device 600. For example, client device 600 may be configured to carry out any of the various subsystem functions disclosed herein—including but not limited to the functions described in connection with FIGS. 2-4. At a high level, client device 600 may generally comprise a processor 602, data storage 604, a communication interface 606, and a user interface 608, all of which may be communicatively linked by a communication link 610 that may take the form of a system bus or some other connection mechanism. Each of these components may take various forms.

For instance, processor 602 may comprise one or more processor components, such as general-purpose processors (e.g., a single-or multi-core microprocessor), special-purpose processors (e.g., an application-specific integrated circuit or digital-signal processor), programmable logic devices (e.g., a field programmable gate array), controllers (e.g., microcontrollers), and/or any other processor components now known or later developed. In line with the discussion above, it should also be understood that processor 602 could comprise processing components that are distributed across a plurality of physical computing devices connected via a network, such as a computing cluster of a public, private, or hybrid cloud.

In turn, data storage 604 may comprise one or more non-transitory computer-readable storage mediums, examples of which may include volatile storage mediums such as random-access memory, registers, cache, etc. and non-volatile storage mediums such as read-only memory, a hard-disk drive, a solid-state drive, flash memory, an optical-storage device, etc. In line with the discussion above, it should also be understood that data storage 604 may comprise computer-readable storage mediums that are distributed across a plurality of physical computing devices connected via a network, such as a storage cluster of a public, private, or hybrid cloud that operates according to technologies such as AWS for Elastic Compute Cloud, Simple Storage Service, etc.

As shown in FIG. 6, data storage 604 may be capable of storing both (i) program instructions that are executable by processor 602 such that the client device 600 is configured to perform any of the various functions disclosed herein (including but not limited to any of the functions described in connection with FIGS. 2-4), and (ii) data that may be received, derived, or otherwise stored by client device 600.

Communication interface 606 may take the form of any one or more interfaces that facilitate communication between client device 600 and other systems or devices. In this respect, each such interface may be wired and/or wireless and may communicate according to any of various communication protocols, examples of which may include Ethernet, Wi-Fi, Controller Area Network (CAN) bus, serial bus (e.g., Universal Serial Bus (USB) or Firewire), cellular network, and/or short-range wireless protocols, among other possibilities.

The client device 600 may additionally include a user interface 608 for connecting to user-interface components that facilitate user interaction with the client device 600, such as a keyboard, a mouse, a trackpad, a display screen, a touch-sensitive interface, a stylus, a virtual-reality headset, and/or speakers, among other possibilities.

It should be understood that client device 600 is one example of a client device that may be used with the embodiments described herein. Numerous other arrangements are possible and contemplated herein.

### CONCLUSION

This disclosure makes reference to the accompanying figures and several example embodiments. One of ordinary skill in the art should understand that such references are for the purpose of explanation only and are therefore not meant to be limiting. Part or all of the disclosed systems, devices, and methods may be rearranged, combined, added to, and/or removed in a variety of manners without departing from the true scope and spirit of the present invention, which will be defined by the claims.

Further, to the extent that examples described herein involve operations performed or initiated by actors, such as “humans,” “curators,” “users” or other entities, this is for purposes of example and explanation only. The claims should not be construed as requiring action by such actors unless explicitly recited in the claim language.

1. A computing platform comprising:
at least one processor;
at least one non-transitory computer-readable medium; and
program instructions stored on the at least one non-transitory computer-readable medium that, when executed by the at least one processor, cause the computing platform to:
generate a network graph that encodes a representation of (i) a plurality of existing data assets stored by the computing platform, (ii) respective relationships between the existing data assets, and (iii) respective consumption activity that indicates, for at least some of the existing data assets, a respective set of interactions involving the existing data asset that includes interactions by two or more users of the computing platform;
receive, as input, an indication of one or more design parameters for a new data asset structure to be used for one or more new data assets;
based on the one or more design parameters for the new data asset structure, select one or more network optimization algorithms to apply to the network graph;
utilize the selected one or more network optimization algorithms to determine an updated network graph;
determine an indication of one or more constraints for the new data asset structure;
based on applying the one or more constraints to the updated network graph, determine a new data asset structure;
output, to a client device associated with a user, an indication of the new data asset structure; and
generate a new data asset according to the new data asset structure, the new data asset comprising data values from one or more of the existing data assets.

2. The computing platform of claim 1, further comprising program instructions that, when executed by the at least one processor, cause the computing platform to:
generate a decision record associated with the new data asset structure, the decision record comprising an indication of (i) the respective consumption activity, (ii) the one or more design parameters, and (iii) the one or more constraints; and
output, to the client device associated with the user, an indication of the decision record.

3. The computing platform of claim 1, wherein the program instructions that, when executed by the at least one processor, cause the computing platform to generate the network graph comprise program instructions that, when executed by the at least one processor, cause the computing platform to:
generate the network graph to further encode a representation of a respective position of each of the two or more users of the computing platform within an organizational hierarchy of an organization.

4. The computing platform of claim 1, wherein the one or more network optimization algorithms comprise one or more of a clustering algorithm, a partitioning algorithm, a centrality algorithm, or a label propagation algorithm.

5. The computing platform of claim 1, further comprising program instructions that, when executed by the at least one processor, cause the computing platform to:
identify, within the consumption activity, one or more action records associated with a given data field of one or more of the existing data assets, wherein the one or more action records indicates user activity that does not satisfy the one or more constraints; and
wherein the program instructions that, when executed by the at least one processor, cause the computing platform to determine the new data asset structure comprise program instructions that, when executed, by the at least one processor, cause the computing platform to:
determine the new data asset structure further based on the identified one or more action records.

6. The computing platform of claim 1, wherein the network graph is a network multigraph.

7. The computing platform of claim 1, further comprising program instructions that, when executed by the at least one processor, cause the computing platform to:
add the one or more new data assets to the plurality of existing data assets; and
generate a new network graph that encodes a representation of the plurality of existing data assets and the new data assets.

8. A non-transitory computer-readable medium, wherein the non-transitory computer-readable medium is provisioned with program instructions that, when executed by at least one processor, cause a computing platform to:
generate a network graph that encodes a representation of (i) a plurality of existing data assets stored by the computing platform, (ii) respective relationships between the existing data assets, and (iii) respective consumption activity that indicates, for at least some of the existing data assets, a respective set of interactions involving the existing data asset that includes interactions by two or more users of the computing platform;
receive, as input, an indication of one or more design parameters for a new data asset structure to be used for one or more new data assets;
based on the one or more design parameters for the new data asset structure, select one or more network optimization algorithms to apply to the network graph;
utilize the selected one or more network optimization algorithms to determine an updated network graph;
determine an indication of one or more constraints for the new data asset structure;
based on applying the one or more constraints to the updated network graph, determine a new data asset structure;
output, to a client device associated with a user, an indication of the new data asset structure; and
generate a new data asset according to the new data asset structure, the new data asset comprising data values from one or more of the existing data assets.

9. The non-transitory computer-readable medium of claim 8, wherein the non-transitory computer-readable medium is also provisioned with program instructions that, when executed by at least one processor, cause the computing platform to:
generate a decision record associated with the new data asset structure, the decision record comprising an indication of (i) the respective consumption activity, (ii) the one or more design parameters, and (iii) the one or more constraints; and
output, to the client device associated with the user, an indication of the decision record.

10. The non-transitory computer-readable medium of claim 8, wherein the program instructions that, when executed by the at least one processor, cause the computing platform to generate the network graph comprise program instructions that, when executed by the at least one processor, cause the computing platform to:
generate the network graph to further encode a representation of a respective position of each of the one two or more users of the computing platform within an organizational hierarchy of an organization.

11. The non-transitory computer-readable medium of claim 8, wherein the one or more network optimization algorithms comprise one or more of a clustering algorithm, a partitioning algorithm, a centrality algorithm, or a label propagation algorithm.

12. The non-transitory computer-readable medium of claim 8, wherein the non-transitory computer-readable medium is also provisioned with program instructions that, when executed by at least one processor, cause the computing platform to:
identify, within the consumption activity, one or more action records associated with a given data field of one or more of the existing data assets, wherein the one or more action records indicates user activity that does not satisfy the one or more constraints; and
wherein the program instructions that, when executed by the at least one processor, cause the computing platform to determine the new data asset structure comprise program instructions that, when executed, by the at least one processor, cause the computing platform to:
determine the new data asset structure further based on the identified one or more action records.

13. The non-transitory computer-readable medium of claim 8, wherein the network graph is a network multigraph.

14. The non-transitory computer-readable medium of claim 8, wherein the non-transitory computer-readable medium is also provisioned with program instructions that, when executed by at least one processor, cause the computing platform to:
add the one or more new data assets to the plurality of existing data assets; and
generate a new network graph that encodes a representation of the plurality of existing data assets and the new data assets.

15. A method carried out by a computing platform, the method comprising:
generating a network graph that encodes a representation of (i) a plurality of existing data assets stored by the computing platform, (ii) respective relationships between the existing data assets, and (iii) respective consumption activity that indicates, for at least some of the existing data assets, a respective set of interactions involving the existing data asset that includes interactions by two or more users of the computing platform;
receiving, as input, an indication of one or more design parameters for a new data asset structure to be used for one or more new data assets;
based on the one or more design parameters for the new data asset structure, selecting one or more network optimization algorithms to apply to the network graph;
utilizing the selected one or more network optimization algorithms to determine an updated network graph;
determining an indication of one or more constraints for the new data asset structure;
based on applying the one or more constraints to the updated network graph, determining a new data asset structure;
outputting, to a client device associated with a user, an indication of the new data asset structure; and
generating a new data asset according to the new data asset structure, the new data asset comprising data values from one or more of the existing data assets.

16. The method of claim 15, further comprising:
generating a decision record associated with the new data asset structure, the decision record comprising an indication of (i) the respective consumption activity, (ii) the one or more design parameters, and (iii) the one or more constraints; and
outputting, to the client device associated with the user, an indication of the decision record.

17. The method of claim 15, wherein generating the network graph comprises generating the network graph to further encode a representation of a respective position of each of the two or more users of the computing platform within an organizational hierarchy of an organization.

18. The method of claim 15, wherein the one or more network optimization algorithms comprise one or more of a clustering algorithm, a partitioning algorithm, a centrality algorithm, or a label propagation algorithm.

19. The method of claim 15, further comprising:
identifying, within the consumption activity, one or more action records associated with a given data field of one or more of the existing data assets, wherein the one or more action records indicates user activity that does not satisfy the one or more constraints; and
wherein determining the new data asset structure comprises determining the new data asset structure further based on the identified one or more action records.

20. The method of claim 15, further comprising:
adding the one or more new data assets to the plurality of existing data assets; and
generating a new network graph that encodes a representation of the plurality of existing data assets and the new data assets.
